(19) United States
(12) Patent Application Publication
(10) Pub. No.: US 2012/0107418 A1
(43) Pub. Date: May 3, 2012

(54) Method and composition for in-situ generation of chlorous acid

(76) Inventor: Roy W. Martin, Downers Grove, IL (US)

(21) Appl. No.: 12/925,714

(22) Filed: Oct. 28, 2010

(51) Int. Cl. A01N 59/08; A01P 1/00

(52) U.S. Cl. 424/665

(57) ABSTRACT

This invention relates to methods and compositions for producing an antimicrobial solution with a high weight percent (wt %) conversion of chlorite anion to chlorous acid and/or derivatives of chlorous acid with substantially reduced chlorite residual. Furthermore, the invention presents methods for use of the antimicrobial solution thereby substantially improving the utility and cost effectiveness of chlorous acid solutions. Furthermore, the invention further demonstrates a method for use of a novel antimicrobial solution comprising a brominated derivative of chlorous acid that has substantially reduced volatility and provides at least two different modes of oxidation.

### FIELD OF INVENTION

This invention relates to methods and compositions for producing an antimicrobial solution with a high weight percent (wt %) conversion of chlorite anion to chlorous acid and/or derivatives of chlorous acid with substantially reduced chlorite residual. Furthermore, the invention presents methods for use of the antimicrobial solution thereby substantially improving the utility and cost effectiveness of chlorous acid solutions. Furthermore, the invention further demonstrates a method for use of a novel antimicrobial solution comprising a brominated derivative of chlorous acid that has substantially reduced volatility and provides at least two different modes of oxidation, thereby providing the benefit of synergistic inactivation of microbiological organisms.

### BACKGROUND

ASC is recognized as a highly potent, broad spectrum antimicrobial system that has been successfully developed for uses in veterinary, food processing and medical device fields. It is a clear, colorless liquid with no foaming capability. It has a mild chlorine-like odor, pH is acid (2.3-3.2), specific gravity of use-solutions (50-1200 ppm) is essentially that of water (1.01-1.05), and weighs approximately 8.39 pounds per gallon. ASC solutions are mixed and immediately applied on site.

Products employing the ASC chemistry have been approved as “devices” for sterilization and disinfection uses in hospitals, dental operation suites, and pharmaceutical clean rooms (e.g., EXSPOR® and LD®). In the animal health market, many ASC solutions (e.g., UDDERgold®, UDDERgold PLUS, PRE-GOLD®, 4XLA®) are drugs approved for dairy industry teat antisepsis. Some ASC formulations are approved for use on food contact surfaces while others (e.g., SANOVA®) are approved as secondary food additives used as antimicrobial for use on poultry, red meat, fruits vegetables, and seafood.

ASC chemistry is principally that of chlorous acid (HClO₂: CAS 14998-27-7), which is the metastable oxychlorine species which forms on acidification of sodium chlorite (CAS 7758-19-2) and, to a lesser extent, chlorine dioxide (CAS 10049-04-4). Chlorous acid and chlorine dioxide, both uncharged, are able to penetrate bacterial cell walls and disrupt protein synthesis by virtue of reactions with sulfhydryl, sulfide, and disulfide containing amino acids and nucleotides. The undissociated acid is thought to facilitate proton leakage into cells and thereby increase energy output of the cells to maintain their normal internal pH thereby also adversely affecting amino acid transport.

U.S. Pat. No. 6,063,425 discloses a method for treating carcasses with a spray comprising from 500 to 1200 ppm of metal chlorite, and sufficient organic acid to obtain a pH from 2.2 to 4.5. The resulting solution shall not have a chlorous acid concentration greater than 35% of the total chlorite ion concentration.

U.S. Pat. No. 5,389,390 discloses a process for treating poultry and other meats to inactivate salmonella by preparing a solution comprising metal chlorite and an acid to achieve a pH from 2.2 to 4.5, resulting in a solution low if chlorine dioxide. The resulting solution shall not have a chorus acid concentration greater than 35% of the total chlorite ion concentration.

U.S. Pat. No. 7,666,384 discloses method and composition for generating chlorine dioxide using a chlorite donor, and acid source and metal bromide absent of any oxidizer other than the chlorite donor.

U.S. Patent Application 2007/0042094 discloses a two-part oxidizing system that comprises a metal chlorite and inorganic acid allowing formation of chlorous acid without the problems associated with using citric acid as the acid.

U.S. Patent Application 2010/0227004 discloses a two-part oxidizing system that comprises a metal chlorite and inorganic acid allowing formation of chlorous acid without the problems associated with using citric acid as the acid.

### SUMMARY

It is well established that the efficacy of acidified chlorite acid systems depends, to a significant degree, on the level of chlorous acid, both absolute and relative, that is present in the solution. Chlorous acid is the source of the antimicrobial oxidants that are transiently formed when the unstable chlorous acid degrades to the more stable reaction products (chloride and chlorate, as well as the oxidant chlorine dioxide). The more rapid the degradation, when bacteria are present in the aqueous system, the more rapidly they are killed.

Prior art antimicrobial solutions comprising chlorous acid using acid activated metal chlorite result in inefficient use of the metal chlorite. For example U.S. Pat. No. 6,063,425 discloses a method for treating carcasses with a spray comprising from 500 to 1200 ppm of metal chlorite. The treatment of beef carcasses with solutions comprising high levels of metal chlorite is necessary due to the poor efficiency of no more than 35 wt % of chlorite conversion to chlorous acid using Acidified Sodium Chlorite (ASC). U.S. Pat. No. 5,389,390 discloses identical limitations.

It has been discovered that the inefficiencies of the prior art ASC methods can be virtually eliminated, and the weight percent yield (wt %) of chlorous acid and its derivatives dramatically increased by modifying the compositions and or chemistry of the antimicrobial solutions disclosed in co-pending U.S. application Ser. Nos. 12/802,230 filed on Jun. 2, 2010; 12/806,964 filed on Aug. 25, 2010, and 12/924,293 filed on Sep. 24, 2010.

By optimizing either the chemistry of the solid compositions and/or buffering the pH of the aqueous solution used to produce the resulting antimicrobial solution so that the pH of the antimicrobial solution is 1.5 to 4.5, more preferably 2.3 to 3.2, the concentration of chlorous acid, both absolute and relative, is dramatically increased, thereby reducing the concentration of chlorite ions and their subsequent waste, as well as the need for excessively elevated molar ratios of acid as disclosed in U.S. Pat. No. 6,063,425.

### DETAILED DESCRIPTION OF THE EMBODIMENT(S)

The invention is particularly applicable to generation of chlorous acid as well as derivatives of chlorous acid having bleaching, biocidal, or virucidal properties and it is in this context that the invention will be described.

As used herein, “metal chlorite” is exemplified by sodium chlorite, potassium chlorite, magnesium chlorite, calcium chlorite and the like. The preferred metal chlorite of the invention comprises sodium chlorite. Metal chlorites provide chlorite anions.

As used herein, “chlorite anion” has the general formula ClO₂⁻.

As used herein, “chlorite anion portion of the metal chlorite” describes the chlorite anion having the general formula ClO₂⁻.

As used herein, “chlorite anion in the form of a metal chlorite” describes the chlorite anion having the general formula ClO₂⁻. Examples of metal chlorite that provide chlorite anion include but are not limited to sodium chlorite, potassium chlorite, and magnesium chlorite.

As used herein “free halogen donor” describes sources of free chlorine (Cl⁺) and free bromine (Br⁺). Free chlorine, when in an aqueous solution comes in the form of Chlorine gas (Cl₂), Hypochlorous acid (HOCl), and/or Hypochlorite ions (OCl⁻) depending on the pH of the aqueous solution. Free bromine, when in an aqueous solution comes in the form of Bromine gas (Br₂), Hypobromous acid (HOBr), and/or Hypobromite ions (OBr⁻) depending on the pH of the aqueous solution. Sources of free chlorine donors and free bromine donors are exemplified in their respective descriptions below.

As used herein, “free bromine donor” comprises donors of Br⁺ when the free bromine donor is in an aqueous solution. Examples of free bromine donors include but are not limited to Dibromodimethylhydantoin (DBDMH) and bromochlorodimethylhydantoin (BCDMH). Free bromine donor includes activated bromide ions exemplified by chlorinated sodium bromide which results in Br⁺. Another free bromine donor comprises a monopersulfate donor exemplified by potassium or sodium monopersulfate and a bromide donor exemplified by sodium bromide. Free bromine donors, when in an aqueous solution form Bromine gas (Br₂), Hypobromous acid (HOBr), and/or Hypobromite ions (OBr⁻) depending on the pH of the aqueous solution.

As used herein, “free chlorine donor” comprises donors of Cl when the free chlorine donor is in an aqueous solution. Examples of free chlorine donors include but are not limited to Dichloroisocyanuric acid (DCCA), Trichloroisocyanuric acid (TCCA), dichlorodimethylhydantoin (DCDMH), sodium hypochlorite and the like. Free chlorine donor includes activated chloride ions exemplified by monopersulfate activation of sodium chloride which results in Cl. Chlorides can be contributed by the sodium chlorite since commercially available sodium chlorite typically comprises several percent sodium chloride. Free chlorine donors, when in an aqueous solution form Chlorine gas (Cl₂), Hypochlorous acid (HOCl), and/or Hypochlorite ions (OCl⁻) depending on the pH of the aqueous solution.

As used herein, “activating oxidizer” describes peroxygen and free halogen donors that convert chlorite anions to chlorous acid and/or chlorine dioxide when reacted in an aqueous solution having a pH from about 1.5 to 4.5, more preferably 2.3 to 3.2. Examples of activating oxidizers include but are not limited to: potassium monopersulfate, sodium monopersulfate, potassium persulfate, trichloroisocyanuric acid (TCCA), dichloroisocyanuric acid (DCCA), dibromodimethylhydantoin (DBDMH), bromochlorodimethylhydantoin (BCDMH), dichlorodimethylhydantoin (DCDMH), and the like.

As used herein, “intermediates of chlorine dioxide” comprise chlorous acid having the general formula HClO₂, and/or chlorine and bromine derivatives of chlorous acid with the proposed general formulas Cl₂O₂ and BrClO₂.

As used herein, “derivatives of chlorous acid” describes chlorous acid intermediates having the proposed general formula Cl₂O₂ and/or BrClO₂.

As used herein, “brominated derivative of chlorous acid” describes chlorous acid intermediate having the proposed general formula BrClO₂.

As used herein, “acid source” include: free mineral acids exemplified by but not limited to sulfuric acid, hydrochloric acid, phosphoric acid, nitric acid; organic acids exemplified by but not limited to citric acid, fumaric acid, tartaric acid, malic acid, succinic acid; inorganic acids exemplified by sodium bisulfate, sodium pyrosulfate, potassium bisulfate. The acid source can be a combination of acids to achieve the desired pH as well as desired level of buffering to compensate for varying water chemistries used to produce the antimicrobial solution. Acid sources may be applied as part of a single composition or separately, such as in the case of pre-treating the aqueous solution prior to producing the antimicrobial solution. This may be desired in applications where the amount of alkalinity in the aqueous solution is sufficient to exceed the acid buffering capacity of a specific composition. Whether all of the acid source is combined as part of a composition or is applied separately, the objective is provide enough acid source to achieve an antimicrobial solution with a pH of 1.5 to 4.5, more preferably 2.3 to 3.2.

As used herein “substantially reduced concentrations of chlorite anion” describes an antimicrobial solution having no more than 40 wt % of the original amount of chlorite anion added to the aqueous solution.

As used herein “substantially free of chlorite anions” describes an antimicrobial solution having no more than 20 wt % of the original amount of chlorite anion added to the aqueous solution.

As used herein, “pH buffered” describes the aqueous solution used to produce the antimicrobial solution is pre-treated with an acid source resulting in an antimicrobial solution having a pH of 1.5 to 4.5, more preferably 2.3 to 3.2.

A “gel-forming material” is comprised of at least a polymer that, upon contact with an aqueous solution, produces a hydrocolloid or hydrogel. The polymer can be natural, such as a gum (i.e. Xanthun gum), semisynthetic such as a polysaccharide (i.e. cellulose derivative), or synthetic such as a poloxamer (block co-polymer of polyoxyethylene and polyoxypropylene), carbomer (crosslinked polymer of acrylic acid), poly(ethylene oxide) and polyvinyl alcohol. The gel-forming material comprises from about 0.1 to 10 wt % of a solid composition in the form of a tablet. The gel-forming material can be used as part of a solid composition in the form of a tablet to improve the weight percent yield of the chlorous acid, as well as provide for a controlled release of the chlorous acid and derivatives of chlorous acid.

As used herein, the term “tablet” refers to any geometric shape or size that comprises the components necessary to produce a solution consisting of at least chlorine dioxide, and wherein the components are gathered together to form a single mass.

As used herein, “non-hygroscopic material” describes a material that coats or encapsulates the reactants and components comprising the solid composition thereby restricting the adsorption of environmental moisture, and forming a barrier between the reactants and components. The non-hygroscopic material is provides from 0.1 to 10 wt % of the composition. The non-hygroscopic material may also absorb moisture thereby functioning as a desiccant as exemplified by magnesium oxide which is converted to virtually insoluble magnesium hydroxide. The properties of the non-hygroscopic material include: low solubility; low bulk density; and small particle size relative to the reactants and components being coated. The solubility of the non-hygroscopic material in 100 ml of 25° C. water shall be no more than 5 grams in 15 minutes at pH 7.0. The bulk density is preferably no more than 40 lbs per cubic foot, and more preferably no more than 20 lbs per cubic foot, and most preferred no more than 10 lbs per cubic foot. The mean average particle size of the non-hygroscopic material is preferably less than 20% of the mean average particle size of the reactants and components the non-hygroscopic material coats, more preferably less than 10% of the mean average particle size of the reactants and components the non-hygroscopic material coats.

As used herein, “food product surface” include: meat carcasses of beef, pork, poultry, and fish; fruit surfaces, and vegetable surfaces.

As used herein, “hard surface” include: countertops; floors; walls; tables; cabinets; doors; doorknobs; food processing equipment, and the like.

As used herein, “surgical instruments” include: endoscopes; scalpels; forceps, and the like.

As used herein, “imide donor” describe nitrogen bonded to at least one carbonyl group (C═O). The general formula representing an imide donor being R¹—NH—R², where R¹ and/or R² are carbon based, and wherein at least one of the carbons comprises a carbonyl group (C═O). Examples of imide donors include but are not limited to: succinimide, glutarimide, dimethylhydantoin, cyanuric acid, and glycoluril.

### Chlorous Acid

In one embodiment, the invention is a method for generating chlorous acid with high efficiency and substantially reduced residual of chlorite anions (high weight percent conversion of chlorite anion to chlorous acid). The method comprises reacting a metal chlorite and a sufficient amount of free halogen donor to convert at least 40 wt %, more preferably 60 wt %, and most preferably at least 80 wt % of the chlorite anion portion of the metal chlorite to chlorous acid and/or derivatives of chlorous acid in an aqueous solution, an acid source resulting in an antimicrobial solution having a pH from about 1.5 to 4.5, more preferably a pH from about 2.3 to 3.2.

In one embodiment, the invention is a method for generating chlorous acid with high efficiency and substantially reduced residual of chlorite anions (high weight percent conversion of chlorite anion to chlorous acid). The method comprises reacting a metal chlorite and a sufficient amount of free halogen donor to convert at least 40 wt %, more preferably 60 wt %, and most preferably at least 80 wt % of the chlorite anion portion of the metal chlorite to chlorous acid and/or derivatives of chlorous acid in an aqueous solution, an acid source resulting in an antimicrobial solution having a pH from about 1.5 to 4.5, more preferably a pH from about 2.3 to 3.2, and an imide donor to stabilize the chlorous acid.

In another embodiment, the invention is a composition for generating chlorous acid with high efficiency and substantially reduced residual of chlorite anions (high weight percent conversion of chlorite anion to chlorous acid). The composition comprises a metal chlorite, a free halogen donor in sufficient amount to convert at least 40 wt %, more preferably 60 wt %, and most preferably at least 80 wt % of the chlorite anion portion of the metal chlorite to chlorous acid and/or derivatives of chlorous acid in an aqueous solution, and an acid source resulting in an antimicrobial solution having a pH from about 1.5 to 4.5, more preferably a pH from about 2.3 to 3.2.

Increasing the conversion of chlorite anion to chlorous acid dramatically improves the cost effectiveness and utility of the antimicrobial solution, reduces waste of expensive metal chlorite, reduces the level of residual metal chlorite on food product surfaces, and reduces the problems associated with treating wastewater containing high levels of chlorite and potentially high levels of organic acids that increase coagulant requirements.

Chlorous acid has higher oxidation potential than aqueous chlorine dioxide and substantially reduced volatility. Based on observations of vapor accumulation of resulting solutions, the inventor has found that the halogen based derivatives of chlorous acid having the proposed general formula BrClO₂ and Cl₂O₂ appear to have even lower volatility, and provide the potential for synergistic inactivation of microbiological organisms by combining halogen derivatives of chlorous acid with chlorous acid oxidation.

An antimicrobial solution comprising chlorous acid with BrClO₂ and/or Cl₂O₂ induces a cascade of intermediates when exposed to microbes thereby enhancing inactivation. The decomposition of chlorous acid and its halogen derivatives results in residual chlorite anions which can be generated back into useful chlorous acid and BrClO₂ and Cl₂O₂ in the presence of residual free halogen and free acidity.

The invention is based on the discovery that antimicrobial solutions can be generated that comprise high levels of chlorous acid and derivatives of chlorous acid with substantially reduced concentrations of chlorite ions. The antimicrobial solutions are generated by combining the mechanisms of acid and free halogen activation of chlorite ions to produce intermediates of chlorine dioxide, and pH buffering of the antimicrobial solution resulting in a pH from about 1.5 to 4.5, more preferably 2.3 to 3.2 resulting in the formation of an antimicrobial solution comprising chlorous acid and derivatives of chlorous acid that is substantially free of chlorite ions.

Without intent to limit the invention to a specific theory or set of theories, the inventor proposes the following mechanisms resulting in the dramatic improvements in chlorous acid yield.

Combining traditional acid activation of chlorite anions with free halogen donors greatly increases the conversion of chlorite anions to derivatives of chlorous acid. By optimizing the pH of the aqueous solution, hydronium ions are produced. As the concentration of free halogen decreases and the molar ratio of hydronium ions to free halogen ions (Cl⁺ and/or Br⁺) increases, kinetics favor displacing the free halogen ions with hydrogen, thereby favoring an equilibrium rich in chlorous acid and formation of free halogen species.

To further expand on this theory, the use of imide donors is believed to further enhance the establishment of an equilibrium that favors chlorous acid over halogen based derivatives of chlorous acid.

It is believed that not only is there a dramatic improvement in the concentration of chlorous acid and derivatives of chlorous acid for a given concentration of chlorite anion initially used, but the equilibrium products comprising derivatives of chlorous acid and/or free halogen donors stabilized with imide donors results in greater antimicrobial efficacy, either resulting from synergistic inactivation and/or greater efficiency for the in-situ generation of chlorous acid upon application of the antimicrobial solutions (the cascading effect). It is important to note the imide donors may be part of the original source of free halogen donor such as in the case of using trichloroisocyanuric acid (TCCA), or dibromodimethyl hydantoin (DBDMH). However, supplemental imide donors may be applied. It would be expected that as the free halogen concentration decreases, the molar ratio of imide donors proportionally increases with respect to the remaining free halogen. An establishment of equilibrium between the imide donors and remaining free halogen would be expected to further influence and favor an equilibrium favoring chlorous acid. An equilibrium favoring chlorous acid would be expected due to the combined effects resulting from the competing reactions comprising: imide donor's affinity for free halogen ions; and high concentrations of hydronium ions favoring displacement of the free halogen ions. The resulting antimicrobial solution, while in equilibrium, would comprise a back and forth cascade of equilibrium products.

To better understand the mechanisms behind the theory, a review of the basic equations follows.

### Chlorite Ion—Halogen System

Where X represents Bromine (Br) and Chlorine (Cl)

2ClO₂⁻+X₂(g)→2ClO₂+2X⁻ (1a)

2ClO₂⁻+HOX→2ClO₂+X⁻+OH⁻ (1b)

However, these equations give a simplistic representation of the generation process. Considering the mechanism of these reactions is important for a better understanding of the details of the generation process and the invention. The intermediate species (XClO₂) forms in these reactions. This intermediate may react to give ClO₂ or chlorate ion according to Equations 3-4.

Where X represents Bromine (Br) and Chlorine (Cl)

X₂+ClO₂⁻→[XClO₂]+X⁻ (2)

2[XClO₂]→2ClO₂+X₂ (3a)

[XClO₂]+ClO₂⁻→2ClO₂+X⁻ (3b)

[XClO₂]+H₂O→ClO₃⁻+X⁻+2H⁺ (4)

Equations 3a-b are important at high concentrations when the formation of XClO₂ is rapid. On the other hand, Equation 4 is more important when the formation of XClO₂ is slow, such as at low reactant concentrations or high pH values.

### Chlorite Ion—Acid System

H⁺+ClO₂⁻ [symbol] HClO₂ (5)

4HClO₂→2ClO₂+ClO₃⁻+Cl⁻+2H⁺+H₂O (6)

5HClO₂→4ClO₂+Cl⁻+H⁺+2H₂O (7)

Combining the Halogen and Acid Activated Chlorite ion systems, and factoring in the pH buffering to sustain a pH of the antimicrobial solution of between 1.5-4.5, more preferably 2.3-3.2, the inventor, without being bound to any specific theory, proposes the following mechanisms resulting in the novel antimicrobial solution.

Where X represents Bromine (Br) and Chlorine (Cl)

X₂+ClO₂⁻→[XClO₂]+X eq. (2)

H⁺ClO₂⁻ [symbol] HClO₂ eq. (5)

The optimized pH buffering results in protonation of water resulting in formation of excess hydronium ions resulting in the proposed equilibrium

[XClO₂]+H₃O⁺ [symbol] HClO₂+XOH+H⁺ Extrapolated versions of eq. (3b and 4)

In the presence of imide donors having the general formula R¹—NH—R², wherein R′ and/or R² comprise at least one carbonyl group (C═O).

XOH+H⁺+R¹—NH—R² [symbol] R¹—NX—R²+H₃O⁺ Continuation of Extrapolated version of eq. (3b-4)

and

[XClO₂]+R¹—NH—R² [symbol] HClO₂+R¹—NX—R² Equilibrium between free halogen and imide donors

As can be observed from Equations 2, 5, and subsequently 3b-4, by combining and optimizing the chemistry of halogen and acid activation of chlorite ions with optimum pH buffering to form a molar excess of hydronium ions, the equations are shifted toward converting halogen based intermediates of chlorine dioxide toward chlorous acid, resulting in an antimicrobial solution comprising chlorous acid and derivatives of chlorous acid with substantially reduced concentrations of chlorite ions. Inclusion of imide donors further shifts the equilibrium toward additional chlorous acid.

Compositions of the invention can be a solid such as in the form of a tablet, granular or powder. Compositions may also comprise liquids or gels. Compositions may also comprise a single mix of components or two or more components comprising solids, liquids, gels or their combination. For example, a liquid metal chlorite can be reacted with a mixture of free halogen donor and acid. Another example may include liquid metal chlorite, liquid acid, and liquid oxidizer.

### Test

A solid composition in the form of a tablet was produced by combining ingredients in their respective wt %, mixing and pressing in a 15 mm die under 10,000 lbs force. The weight percent are as follows:

| | |
|---|---|
| Sodium chlorite (34.5 wt % as chlorite anion) | 57.0% |
| Fumaric acid | 18.0% |
| TCCA (18.9 wt % as Cl₂) | 21.0% |
| PVA | 2.0% |
| MgO | 0.5% |
| MgCO₃ | 0.5% |
| MgSO₄ | 1.0% |

Three tablets, comprised of the disclosed composition where added to 3-separate Erlenmeyer flask each having 120 ml of water. Flask #1 comprised tap water and a 2.13 gram tablet. Flask #2 had tap water with the pH buffered to 2.6 using sodium bisulfate and citric acid and a 2.10 gram tablet. Flask #3 had tap water with the 0.25 grams of sodium bromide and a 2.11 gram tablet.

Each flask had one tablet added, and the flask was covered. After 40 minutes each flask was swirled resulting in a homogenous solution.

Flask #1—during the chlorous acids formation, there was an apparent vapor cloud above the liquid level. Upon completion of the tablet dissolution, only a slight appearance of vapor was present. The solution was gold in color. The pH was 3.0.

Flask #2—far less vapor was observed during the formation of the chlorous acid. The final solution was darker gold than flask #1. The pH was 2.6.

Flask #3—virtually no observed vapor during or after formation of chlorous acid and what is expected to be the bromine derivative of chlorous acid (BrClO₂). The appearance was amber in color, and the pH was 3.1.

A 1 ml sample from flask #1 was added to 99 ml in a graduated cylinder and decanted back and forth between graduated cylinders until intimately mixed. A 25 ml sample was added to a flask, DPD reagent was added swirled forming a dark red solution. The sample was swirled and titrated with standardized FAS-DPD titrating reagent resulting in 310 standardized drops, equating to 6200 ppm as Cl₂, or approximately 6,000 ppm as HClO₂. The activation of DPD reagent and subsequent titration indicates over 95 wt % of all of the available chlorite anion was converted to desirable active species comprising chlorous acid, derivatives of chlorous acid, and residual chlorine dioxide.

The preferred chlorite donor is sodium chlorite. However other chlorite donors that provide chlorite anions (ClO₂⁻) when dissolved in water could be used in the composition exemplified by potassium chlorite, magnesium chlorite and various metal chlorites.

Free halogen donors contribute halogen based oxidizers when contacted with an aqueous solution. For example, Trichloroisocyanuric acid (TCCA) releases free chlorine as it is dissolved by water. The species of the free chlorine is dependent on the pH of the solution. The species of free chlorine can include Cl₂, HOCl, and OCl⁻. The species of free bromine can include Br₂, HOBr, and OBr⁻.

An acid source consumes the hydroxide alkalinity released from the chlorite donor and neutralizes alkalinity in the aqueous solution. The pH of the resulting antimicrobial solution shall be 1.5 to 4.5, more preferably 2.3 to 3.2. The Acid sources can be organic and inorganic. Examples of acid sources include but are not limited to sodium bisulfate, sodium pyrosulfate, succinic acid, fumaric acid, tartaric acid, and citric acid. Examples of inorganic acid sources include but are not limited to sodium bisulfate potassium bisulfate, sodium pyrosulfate and the like. Liquid forms of acid include mineral acids such as sulfuric acid, phosphoric acid, hydrochloric acid and the like.

### Optional Components

### 1) Wetting Agents

Wetting agents can be used in combination with the antimicrobial solution to enhance distribution and penetration of biofilms. Examples of wetting agents include but are not limited to: alkylphenoxypoly(ethylene oxide), poly(ethylene oxide/propylene oxide) block copolymer, alkylbenezene sulfonic acid, dioctylsulfosuccinate, and the like.

### 2) Surfactants

In some instances surfactants can be combined with the antimicrobial solutions to increase detergency, produce foams, provide wetting, and the like. Alkyl polyglycosides are generally regarded as safe and provide good foaming and detergency. Surfactants for use with the antimicrobial solutions of the invention are preferably non-ionic.

### 3) Hydrogen Peroxide Donor

Peroxide donors include but are not limited to: hydrogen peroxide, urea peroxide, sodium peroxide, calcium peroxide, sodium percarbonate, sodium perborate and the like. When peroxide donors exemplified by sodium perborate are pH buffered to provide an acid pH value, hydrogen peroxide is stabilized. The peroxide can induce a synergistic effect as well as convert residual chlorite anions to chlorous acid.

What is claimed is:

1. A solid composition that produces an antimicrobial solution when contacted with an aqueous solution, the composition comprising: a source of chlorite anion in the form of a metal chlorite providing from about 10-40 wt % reported as chlorite anion; a free halogen donor in an amount from 10-58 wt % reported as Cl₂ and in sufficient amount resulting in at least 40 wt % conversion of the chlorite anion to chlorous acid and/or derivatives of chlorous acid; an acid source ranging from about 3-50 wt % and in sufficient amount to provide a pH of no more than 4.5 when 1 gram of the solid composition is dissolved in 25 ml of water; the antimicrobial solution having a pH from 1.5 to 4.5, and
wherein, all wt % being based on the total weight of the composition unless otherwise stated.

2. The antimicrobial solution according to claim 1, wherein the aqueous solution is pH buffered resulting in the antimicrobial solution with a pH ranging from 2.3 to 3.2.

3. The solid composition according to claim 1, wherein the solid composition is in the form of a tablet.

4. The solid composition according to claim 3, wherein the tablet comprises from 0.1 to 10 wt % of a gel-forming material.

5. The solid composition according to claim 3, wherein the tablet comprises from 0.1 to 10 wt % of a non-hygroscopic material coating at least the metal chlorite.

6. The solid composition according to claim 1, wherein the solid composition is in the form of granules or powder.

7. The solid composition according to claim 1, wherein the activating oxidizer is a free halogen donor.

8. The free halogen donor according to claim 7, wherein the free halogen donor is trichloroisocyanuric acid.

9. The free halogen donor according to claim 7, wherein the free halogen donor is dichloroisocyanuric acid.

10. The free halogen donor according to claim 7, wherein the free halogen donor is dibromodimethylhydantoin.

11. The free halogen donor according to claim 7, wherein the free halogen donor is bromochlorodimethylhydantoin.

12. The free halogen donor according to claim 7, wherein the free halogen donor comprises a free bromine donor.

13. The free bromine donor according to claim 12, wherein the free bromine donor comprises a monopersulfate donor and bromide donor.

14. The solid composition according to claim 6, wherein the solid composition in the form of granules or powder comprises a single mixture.

15. The solid composition according to claim 6, wherein the solid composition in the form of granules or powder comprising at least two-parts.

16. The antimicrobial solution according to claim 1, further comprising a wetting agent.

17. The antimicrobial solution according to claim 1, further comprising hydrogen peroxide.

18. The solid composition according to claim 1, wherein the free halogen donor is in sufficient amount resulting in at least 60 wt % conversion of the chlorite anion to chlorous acid and/or derivatives of chlorous acid.

19) The solid composition according to claim 1, wherein the free halogen donor is in sufficient amount resulting in at least 80 wt % conversion of the chlorite anion to chlorous acid and/or derivatives of chlorous acid.

20) A method for producing an antimicrobial solution comprising chlorous acid and/or derivatives of chlorous acid, the method comprising:
adding a metal chlorite, an acid source, and a free halogen donor into an aqueous solution; an acid source in sufficient concentration to achieve a pH of the aqueous solution of no more than 4.5; a sufficient concentration of free halogen donor to convert at least 50 weight percent of the chlorite anion to chlorous acid and/or derivatives of chlorous acid, and
wherein, the resulting antimicrobial solution has a pH of about 1.5 to 4.5, and substantially reduced concentrations of chlorite anion.

21) The method according to claim 20, wherein the pH of the antimicrobial solution is about 2.3 to 3.2.

22) The method according to claim 20, comprising a sufficient concentration of the free halogen donor to convert at least 70 weight percent of the chlorite anion to chlorous acid and/or derivatives of chlorous acid.

23) A method for disinfecting a food product surface, the method comprising:
contacting a solid composition with an aqueous solution to produce an antimicrobial solution comprising chlorous acid and/or a derivative of chlorous acid, wherein the composition comprising a source of chlorite anion in the form of a metal chlorite providing from about 10-40 wt % reported as chlorite anion; a free halogen donor in an amount from 10-58 wt % reported as Cl₂ and in sufficient amount resulting in at least 40 wt % conversion of the chlorite anion to chlorous acid and/or derivatives of chlorous acid; an acid source ranging from about 3-50 wt % and in sufficient amount to provide a pH of no more than 4.5 when 1 gram of the solid composition is dissolved in 25 ml of water; the antimicrobial solution having a pH from 2.2 to 4.5, and all wt % being based on the total weight of the composition unless otherwise stated; and
contacting the surface with said antimicrobial solution to provide from 1 to 500 ppm based on the chlorous acid and/or derivatives of chlorous acid concentration of the antimicrobial solution.

24) A method for disinfecting a hard surface, the method comprising:
contacting a solid composition with an aqueous solution to produce an antimicrobial solution comprising chlorous acid and/or a derivative of chlorous acid, wherein the composition comprising a source of chlorite anion in the form of a metal chlorite providing from about 10-40 wt % reported as chlorite anion; a free halogen donor in an amount from 10-58 wt % reported as Cl₂ and in sufficient amount resulting in at least 40 wt % conversion of the chlorite anion to chlorous acid and/or derivatives of chlorous acid; an acid source ranging from about 3-50 wt % and in sufficient amount to provide a pH of no more than 4.5 when 1 gram of the solid composition is dissolved in 25 ml of water; the antimicrobial solution having a pH from 2.2 to 4.5, and all wt % being based on the total weight of the composition unless otherwise stated; and
contacting the surface with said antimicrobial solution to provide from 1 to 2000 ppm based on the chlorous acid and/or derivatives of chlorous acid concentration of the antimicrobial solution.

25) A method for disinfecting surgical instruments, the method comprising:
contacting a solid composition with an aqueous solution to produce an antimicrobial solution comprising chlorous acid and/or a derivative of chlorous acid, wherein the composition comprising a source of chlorite anion in the form of a metal chlorite providing from about 10-40 wt % reported as chlorite anion; a free halogen donor in an amount from 10-58 wt % reported as Cl₂ and in sufficient amount resulting in at least 40 wt % conversion of the chlorite anion to chlorous acid and/or derivatives of chlorous acid; an acid source ranging from about 3-50 wt % and in sufficient amount to provide a pH of no more than 4.5 when 1 gram of the solid composition is dissolved in 25 ml of water; the antimicrobial solution having a pH from 2.2 to 4.5, and all wt % being based on the total weight of the composition unless otherwise stated; and
contacting the surface with said antimicrobial solution to provide from 20 to 2000 ppm based on the chlorous acid and/or derivatives of chlorous acid concentration of the antimicrobial solution.
